(19) United States
(12) Patent Application Publication
(10) Pub. No.: US 2004/0267539 A1
(43) Pub. Date: Dec. 30, 2004

(54) METHOD FOR GENERATING OUTPUT SOUND DATA IN A PREDETERMINED TIME PERIOD

(76) Inventor: Gin-Der Wu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,978

(22) Filed: Aug. 29, 2003

(30) Foreign Application Priority Data
Jun. 30, 2003 (TW) 092117872

(51) Int. Cl. G10L 11/00

(52) U.S. Cl. 704/278

(57) ABSTRACT

A method for generating output sound data in a predetermined time period includes mixing input sound data in the predetermined time period with input sound data in the time period previous to the predetermined time period, and with output sound data in the time period previous to the predetermined time period in order to generate the output sound data in the predetermined time period.

### BACKGROUND OF INVENTION

1. Field of the Invention

The present invention relates to a method for generating output sound data in a predetermined time period, and more specifically, to a method for generating output sound data that is capable of adjusting the proportion of echo and reverberation.

2. Description of the Prior Art

Modern music often includes echoes. This is because sound waves from musical instruments and voices are reflected from the surrounding environment and the resulting echoes become a part of the music.

In order to simulate echoes, a mechanical echo simulator such as a spring or a special metal plate is often used to generate an echo effect in the prior art. However, in such mechanical echo simulators, only the volume can be adjusted so that the echo effect is limited.

However, as electrical acoustic systems progress, digital sound synthesizers have become mainstream because it is much easier to change the characteristics of digital signals.

Please refer to FIG. 1 showing a block diagram of a conventional digital sound synthesizer 20 according to the prior art. The digital sound synthesizer 20 includes a delay element 22, a mixer 24, an attenuator 26, and a memory unit 28. The sound synthesizer 20 is for simulating an echo effect. When delaying a sound input for a specific time period as stored in the memory unit 28, the input sound (shown as “IN” in FIG. 1)firstly passes throughthe attenuator 26. It is thendelayed by the delay element 22 for a predetermined time ΔT, and is then combined with the original sound input after the predetermined time by the mixer 24 to generate a sound signal accompanied with an echo (as shown as “OUT” in FIG. 1). Please refer to FIG. 2 showing the response of a pulse signal at each delay time. As shown in FIG. 2, the real sound will attenuate after generated. In order to generate an output sound o(t) at t second, both an input sound i(t) and an echo of the previous sound input is required. In the case of using the structure shown in FIG. 1 to simulate echoes, since the structure only delays an input sound i(t-ΔT) before the predetermined time periodΔT, the output sound o(t)=i(t)+k*i(t−ΔT), wherein k is an attenuation parameter of the attenuator. Obviously, as shown by FIG. 1, the output sound o(t) does not include input sounds such as i(t−2ΔT) and i(t−3ΔT). Therefore, the output sound simulated by the sound synthesizer 20 does not attenuate gradually and is not natural. For a better echo effect, more space in the memory unit 28 is required to store input sounds in a longer time period, so that the output sound o(t)=i(t)+k*i(t−ΔT)+k²*i(t−2ΔT)+k³*i(t−3ΔT)+. . . will approach the real sound. Thus, in order to simulate a larger echo, a large spaced memory unit 28 is required to store i(t), i(t−ΔT), i(t−2ΔT), i(t−3ΔT) and even more sounds input in other time periods, so that not only a larger memory space is required, but also an additional delay element 22 and an additional attenuator 26 are required for each input sound i(t−nΔT).

In consideration of the problem mentioned above, another sound synthesizer design has been developed. Please refer to FIG. 3 showing a block diagram of another sound synthesizer 10 according to the prior art. The sound synthesizer 10 includes a delay element 12, a mixer 14, and an attenuator 16. The mixer 14 is for mixing undelayed sound data from an input port (shown as “IN” in FIG. 3) and sound data delayed by the delay element 12 from the output port (shown as “OUT” in FIG. 3), in order to generate a sound signal accompanied with an echo. The delay element 12 is for delaying the output of the mixer 14 by a predetermined timeΔT, and the attenuator 16 is for attenuating the output of the delay element 12. Using the structure shown in FIG. 3, output sound o(t)=i(t)+k*o(t−ΔT), and o(t−ΔT)=i(t−ΔT)+k*o(t−2ΔT), o(t−2ΔT)=i(t−2ΔT)+k*o(t−3ΔT), thus o(t)=i(t)+k*i(t−ΔT)+k ²*i(t−2ΔT)+k³*i(t−3ΔT)+. . . , wherein k is the gain of the attenuator 16 which is between 0 and 1, and the predetermined time of the delay element 12 is ΔT. The sound synthesizer 10 solves the problems in FIG. 1 by only keeping the two sound parameters i(t) and o(t−ΔT). In such a manner, the output sound is not a single echo but compensated by a group of echoes. However, if the attenuating parameter α(α(=1−k) is too small, the output sound will not attenuate enough so that the group of echoes will betoolarge and overpower the output sound. If the attenuating parameter α is too large, the echo effect will not be obvious. Therefore, it is a target to design a sound synthesizer which can make the first echo obvious while reducing the remaining group of echoes. Using the synthesizer 20 shown in FIG. 1, the output sound does not include a group of echoes. When using the synthesizer 10 shown in FIG. 3, because the sound synthesizer 10 needs a smaller attenuating parameter to make the first echo obvious, strong following subsequent echoes and reverberation overpower the output sound. Therefore, it is important to improve the prior art.

### SUMMARY OF INVENTION

It is therefore a primary object of the present invention to provide a method for outputting sound data in which the proportion of echo and reverberation can be adjusted, so that the output sound data has a proper first echo effect and is compensated by a group of echoes, and memory space is reduced as well.

Briefly summarized, a method for generating output sound data in a predetermined time period includes mixing input sound data in the predetermined time period with input sound data in a time period previous to the predetermined time period, and output sound data in the time period previous to the predetermined time period in order to generate the output sound data in the predetermined time period.

The present invention furtherdiscloses a sound synthesizer comprising an input port for inputting sound data, an output port for outputting sound data, and a logic unit for mixing input sound data in a predetermined time period from the input port with input sound data in a time period previous to the predetermined time period from the input port, and output sound data in the time period previous to the predetermined time period from the output port, in order to generate the output sound data in the predetermined time period.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional digital sound synthesizer according to the prior art.

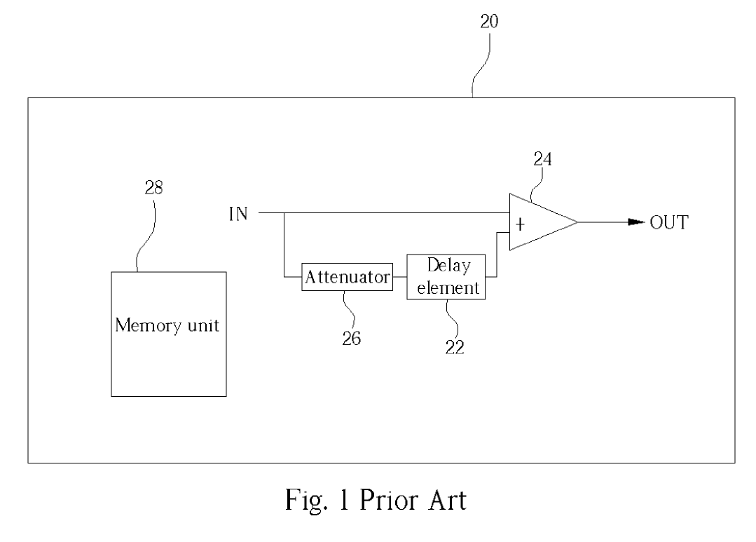

FIG. 2 illustrates the response of a pulse signal in each delay time.

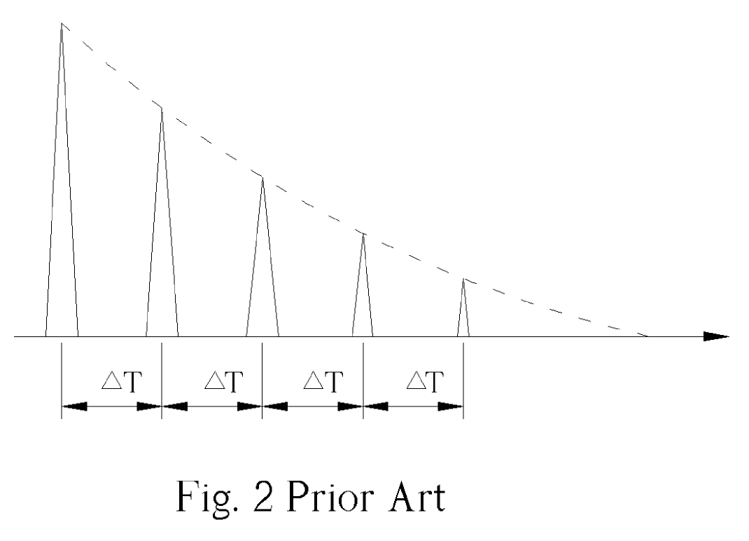

FIG. 3 is a block diagram of another sound synthesizer according to the prior art.

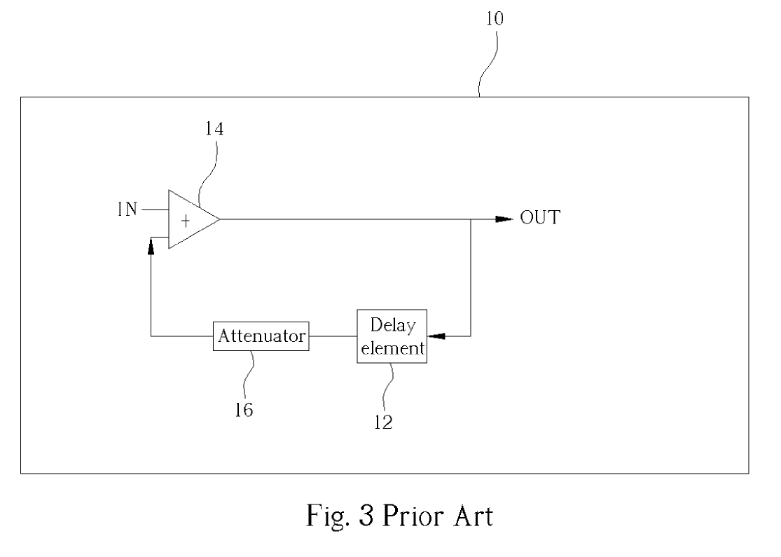

FIG. 4 is a block diagram of a sound synthesizer according to the present invention.

FIG. 5 is a flowchart of the operations by the logic unit to convert sound data.

FIG. 6 illustrates distribution of memory spaces during operation.

FIG. 7 further illustrates distribution of memory spaces during operation.

### DETAILED DESCRIPTION

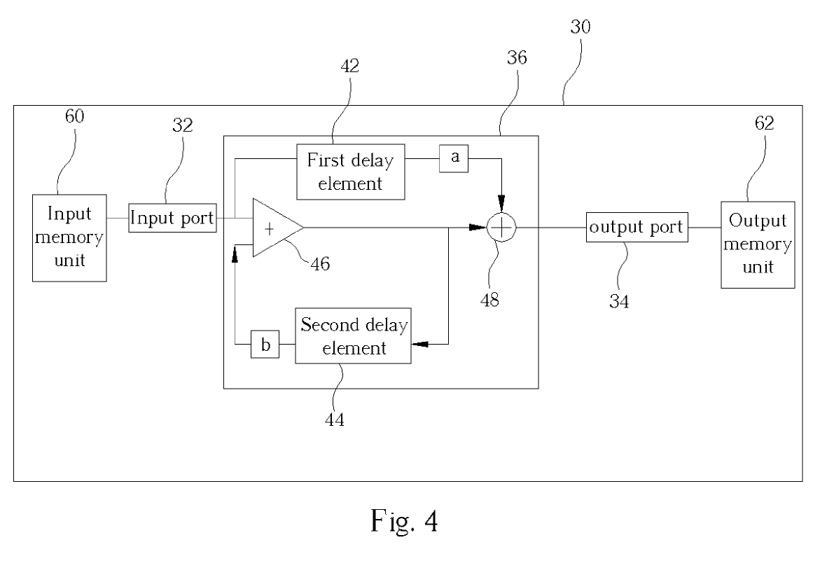

Please refer to FIG. 4 showing a block diagram of a sound synthesizer 30 according to the present invention. The sound synthesizer 30 includes an input port 32, an output port 34, an input memory unit 60, an output memory unit 62, and a logic unit 36. The logic unit 36 includes a first delay element 42, a second delay element 44, a first mixer 46, and a second mixer 48. The input port 32 is for inputting sound data, the first delay element 42 is for delaying the sound data from the input port 32, the first mixer 46 is for mixing the sound data from the input port 32 with an input signal generated by delaying an output signal of the first mixer 46, the second delay element 44 is for delaying the output signal of the first mixer 46, and the second mixer 48 is for mixing the output signal of the first mixer 46 with the sound data delayed by the first delay element 42. In other words, the second delay element 44 and the first mixer 46 compose a feedback loop. Finally, the output port 34 outputs the sound data mixed by the second mixer 48.

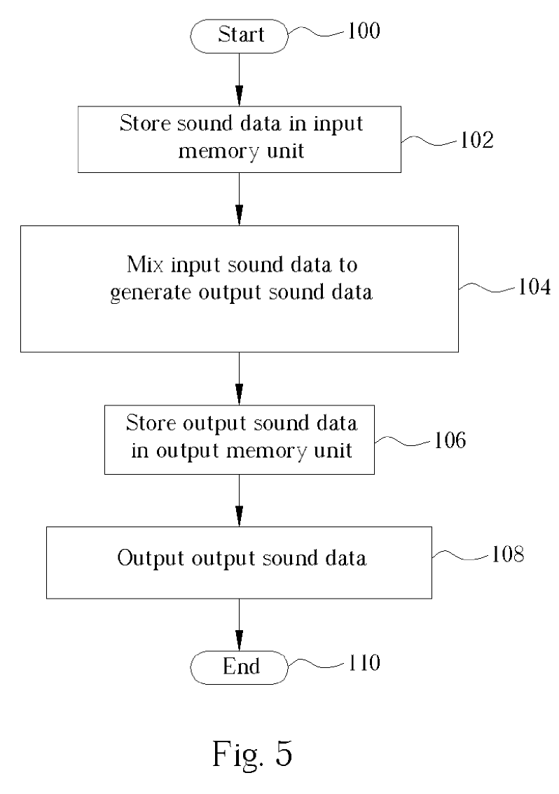

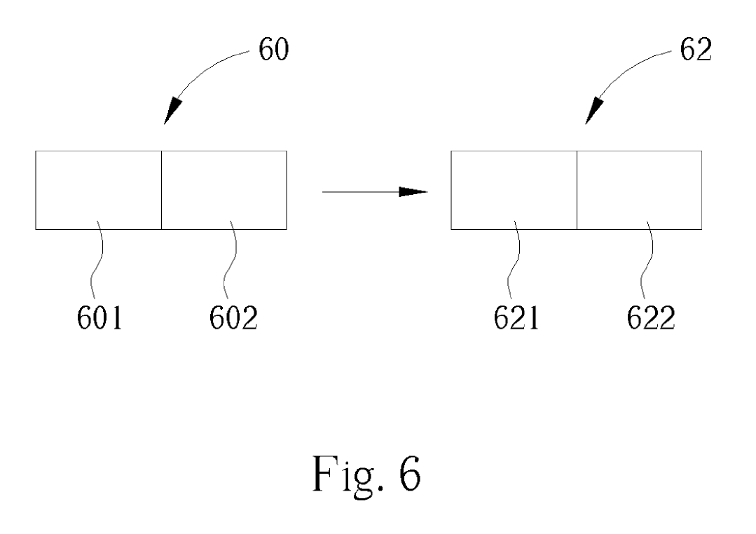

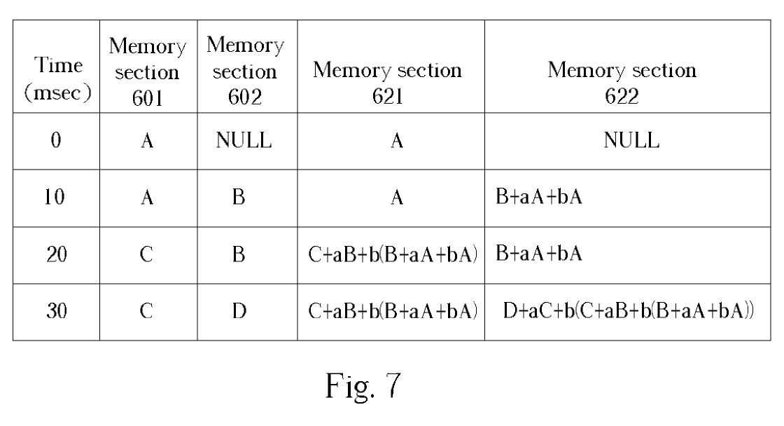

In order to describe the present invention more clearly, please refer to FIG. 5 to FIG. 7. FIG. 5 shows a flowchart of the operation of the logic unit 36 used to convert sound data. FIG. 6 and FIG. 7 show distribution of memory spaces during the operations. The sound synthesizer 30 provides the input memory unit 60 for storing input sound data and the output memory unit 62 for outputting sound data according to the input sound data. The flow of the sound synthesizer 30 generating sound data with echoes is described as follows:

Step 100: Start. At this time the initial values of the input memory unit 60 and the output memory unit 62 are nulls.

Step 102: Input sound data in a predetermined time period by the input port 32 into the input memory unit 60.

Step 104: The logic unit 36 mixes the sound data in the predetermined time period with the product of sound data input in the previous time period using a first attenuating value a, and with the product of sound data output in the previous time period with a second attenuating value b.

Step 106: Store the output sound data in the predetermined time period in the output memory unit 62.

Step 108: Output the output sound data stored in the output memory unit 62 from the output port 34.

Step 110: End.

For a moreclear description, assume that the input memory unit 60 has two memory sections 601, 602 and the output memory unit 62 has also two memory sections 621, 622 of the same length, that is, these sections can store sound data of the same length such as 10 msec (but not limited to 10 msec). The processing of sound data is described as follows. Firstly, original sound data A is stored in the memory section 601 of the input memory unit 60 through the input port 32. The logic unit 36 then processes the sound data A input in the predetermined time period as described in Step 104. Since the memory sections 602, 621, 622 are all nulls, the output sound data remains A and is stored in memory section 621 and output by the output port 34. At time 10 msec, input sound data B is stored in the memory section 602, and the logic unit 36 processes the input sound data as described in Step 104 to generate output sound data resulting in B+aA+bA. It then stores the output sound data in memory section 622 and outputs the sound data from the output port 34. At time 20 msec, new sound data C is stored in the memory section 601, and the logic unit 36 processes the input sound data as described in Step 104 to generate output sound data resulting in C+aB+b(B+aA+bA). It then stores the output sound data in memory section 621. At time 30 msec, sound data D is stored into memory section 602, and the logic unit 36 processes the input sound data as described in Step 104 to generate output sound data resulting in D+aC+b(C+aB+b(B+aA+bA)). It then stores the output sound data in memory section 622. Continuing, the logic unit 36 repeats these steps until there is no more input sound data. As described above, after 30 msec, the first echo effect at 20 msec remains apparent after being attenuatedwith the proper control, that is, by keeping the parameter b less than the parameter a, the previous input sound (i.e. input sound B at 10 msec and input sound A at 0 msec) will attenuate rapidly at 30 msec so that those echoes will not last for a long time.

In the case of sound synthesizer 20, if a loud first echo effect is required, because the synthesizer 20 can only mix sound input in the previous time period i(t−ΔT) but not i(t−2ΔT), i(t−3ΔT), the output sound will not be compensated by a group of echoes. And in the case of sound synthesizer 10, for a loud first echo effect, the attenuating parameter is required to remain small, so that not only a strong first echo will be generated, but also the continuing echoes will last for a long time. In contrast to this, the present invention provides a method to keep a large parameter a while reducing the parameter b less than the parameter a. In such a manner, a loud first echo is generated and the continuing echoes will not last too long.

In practical applications, the logic unit 36 in FIG. 4 can also be implemented with program code stored in the sound synthesizer.

In contrast to the prior art, the sound synthesizer mixes sound data input in a predetermined time period with sound data input in the time period previous to the predetermined time period, and sound data output in the time period previous to the predetermined time period. This strengthens the sound data input in the time period previous to the predetermined time period properly to make a loud first echo, and weakens the sound data output in the time period previous to the predetermined time period as well. In addition, the method according to the present invention has another advantage in saving memory space, which is a further improvementover the prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for generating output sound data in a predetermined time period comprising:
mixing input sound data in the predetermined time period with input sound data in the previous time period, and with output sound data in the previous time period in order to generate the output sound data in the predetermined time period.

2. The method of claim 1, using a sound synthesizer to generate the output sound data in the predetermined time period.

3. A sound synthesizer comprising:
an input port for inputting sound data;
an output port for outputting sound data; and
a logic unit for mixing input sound data in a predetermined time period from the input port with input sound data in the previous time period from the input port, and with output sound data in the previous time period from the output port, in order to generate the output sound data in the predetermined time period.

4. The sound synthesizer of claim 3, wherein the logic unit comprises:
a first delay element for delaying the input sound data from the input port;
a first mixer for mixing the input sound data from the input port and an input signal generated by delaying an output signal from the first mixer;
a second delay element for delaying the output signal from the first mixer; and
a second mixer for mixing the output signal from the first mixer with the sound data delayed by the first delay element.

5. The sound synthesizer of claim 3, further comprising a memory, wherein the logic unit comprises program code stored in the memory.
